(19) United States
(12) Patent Application Publication
(10) Pub. No.: US 2026/0203832 A1
(43) Pub. Date: Jul. 16, 2026

(54) DRIVING DISTRIBUTION MATRIX SYSTEM FOR DRIVER SCORING AND RISK ASSESSMENT

(71) Applicant: Nexar Ltd., Tel Aviv (IL)

(72) Inventors: Lev Yitzhak Lavy, Misgav Dov (IL); Daniel Cardoso de Moura, Gulphilhares (PT); Ilan Kadar, Tel Aviv (IL)

(21) Appl. No.: 19/235,584

(22) Filed: Jun. 12, 2025

Related U.S. Application Data
(60) Provisional application No. 63/666,170, filed on Jun. 30, 2024.

(51) Int. Cl. G06Q 40/08; G06N 3/08

(52) U.S. Cl. CPC G06Q 40/084; G06N 3/08; G06Q 40/09

(57) ABSTRACT

A system for vehicle insurance actuaries, including a data collector aggregating dynamic vehicle data from sensors, the data including vehicle speed and acceleration, the vehicle being driven by a driver, a data processor generating a data driver distribution matrix (DDM) from the data collected by the data collector, and pre-processing the DDM, a convertor, representing the data DDM output by the data processor by a graphic DDM, a server computer, training a model to learn important features of graphics that are related to likelihood of drivers submitting an insurance claim, and to assign driver scores based on graphics, and a transmitter transmitting the graphic DDM to the server computer, wherein the server computer receives the graphic DDM from the transmitter, computes a driver score from the graphic DDM, based on the model, and infers the likelihood of the driver submitting an insurance claim, based on the driver score.

### REFERENCE TO RELATED APPLICATION

This application is a non-provisional application claiming the benefit of US Provisional Application No. 63/666,170 filed on Jun. 30, 2024, the contents of which are incorporated herein by reference in their entirety.

### FIELD OF THE INVENTION

The present invention relates to actuaries for vehicle insurance.

### BACKGROUND OF THE INVENTION

Insurance companies and fleets commonly use aggregated data from drivers' vehicles using telemetry devices to estimate drivers scores, which are used to estimate risk, set insurance cost and/or give driver feedback. The aggregated data includes driving telemetry events such as braking, accelerating and cornering, which are generally gathered using means such as accelerometer, global positioning system (GPS), on-board diagnostic (OBD) vehicle speed and inertial measurement systems (IMU). These events are sparse and set from a predetermined threshold.

While this method is effective, the convergence time and accuracy may be significantly improved, to yield faster and more accurate results.

An example of a conventional method to estimate the likelihood of drivers developing insurance claims is based on the frequency of hard brakes. A higher frequency of hard brakes is associated with a higher likelihood of developing insurance claims. This approach has, however, some drawbacks.
1. Frequency: Since hard brakes are infrequent events, one needs to collect tens to hundreds of thousands of miles to score a driver with confidence; having an event for every X thousand miles is therefore a sparse representation of drivers' behavior.
2. Completeness: Hard brakes are not the only events associated with bad driving; for example, harsh accelerations also help identify reckless driving.
3. Profiling: The association between speed and acceleration is not captured.
4. Thresholding: Classifying a brake as a hard brake requires a rule based on an acceleration threshold to make a binary decision. Braking with accelerations near the threshold is randomly classified as hard or normal. In addition, this threshold might have different impact and meaning depending on the vehicle type.

Reference is made to FIG. 1, which is a graph showing results of a study shared with an insurance company, where there is a positive correlation between hard brakes (incidents) and insurance claims, normalized by mileage. The gray bar highlights an drawback with the classical approach, whereby 12% of insurance claims are associated with devices without incidents. The default threshold is too high for some vehicles.

### SUMMARY

The present invention provides a method whereby a Driver Distribution Matrix (DDM), a 2D matrix represented by a histogram that aggregates bins of speed vs. acceleration data, is collected and used instead of telemetry events as a basis for computing driver score, collision risk and cost assessment. One embodiment of the present invention is based on speed provided at intervals of one second, where in each such interval the peak acceleration is sampled at 4 Hz from an accelerometer.

There is thus provided in accordance with an embodiment of the present invention a system for vehicle insurance actuaries, including a data collector aggregating dynamic vehicle data from sensors, the data including vehicle speed and acceleration, the vehicle being driven by a driver, a data processor generating a data driver distribution matrix (DDM) from the data collected by the data collector, and pre-processing the DDM, a convertor, representing the data DDM output by the data processor by a graphic DDM, a server computer, training a model to learn important features of graphics that are related to likelihood of drivers submitting an insurance claim and to likely cost of claims submitted, and to assign driver scores based on graphics, and a transmitter transmitting the graphic DDM to the server computer, wherein the server computer receives the graphic DDM from the transmitter, computes a driver score from the graphic DDM, based on the model, and infers the likelihood of the driver submitting an insurance claim and the likely cost of the submitted claim, based on the driver score.

There is additionally provided in accordance with an embodiment of the present invention a method for predicting likelihood of an insurance claim by a driver, including aggregating dynamic vehicle data from sensors in a vehicle, the data including vehicle speed and acceleration, the vehicle being driven by a driver, generating a data driver distribution matrix (DDM) from the data collected by the aggregating, pre-processing the DDM generated by the generating, representing the pre-processed DDM by a graphic DDM, training a model to learn important features of graphics that are related to likelihood of drivers submitting an insurance claim and to likely cost of claims submitted, and to assign a driver score based on a graphic, computing a driver score from the graphic DDM, based on the model, and inferring the likelihood of the driver submitting an insurance claim and the likely cost of the submitted claim, based on the driver score.

### BRIEF DESCRIPTION OF THE DRAWINGS

The present invention will be more fully understood and appreciated from the following detailed description, taken in conjunction with the drawings in which:

FIG. 1 is a prior art graph showing a positive correlation between hard brakes (incidents) and insurance claims;

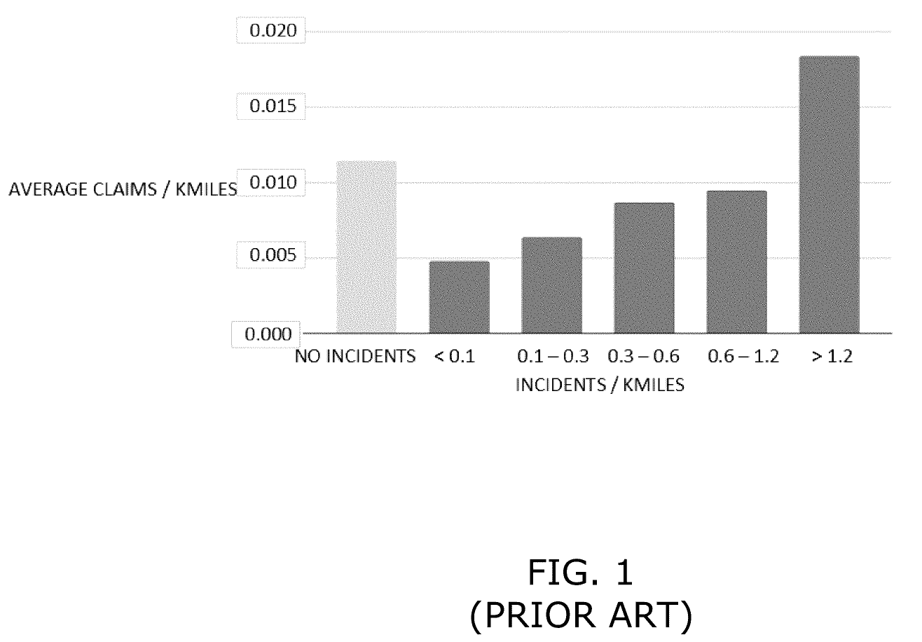

FIG. 2 is a graphic representation of a DDM, showing distribution of braking and acceleration vs. speed, in accordance with an embodiment of the present invention;

FIG. 3 is a simplified drawing showing how DDMs describe different driver profiles, in accordance with an embodiment of the present invention;

FIG. 4 is a simplified image showing the importance of the different areas of DDMs to the model, in accordance with an embodiment of the present invention;

FIG. 5 is a simplified drawing of a method for inferring the score based on a DDM using a neural network trained on DDM and insurance claim data in accordance with an embodiment of the present invention; and

FIG. 6 is a graph showing correlation between the network score and the likelihood of developing an insurance claim, in accordance with an embodiment of the present invention.

### DETAILED DESCRIPTION

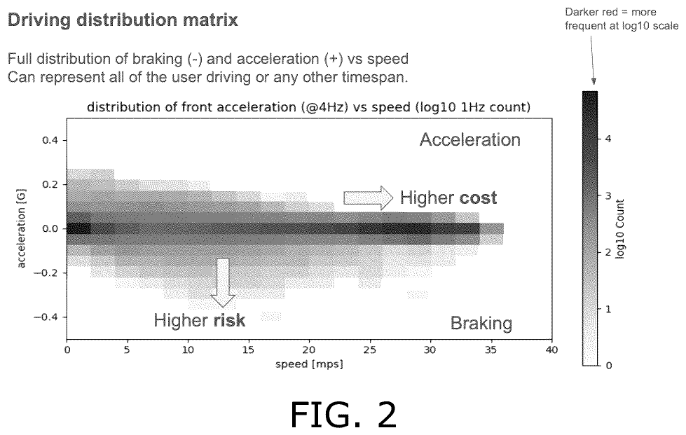

A Driver Distribution Matrix (DDM) is a matrix that stores many types of telemetry data such as acceleration/braking, cornering and even data coming from vision as headway, collected at time intervals and binned according to speed. Reference is made to FIG. 2, which is a graphic representation of a DDM, showing distribution of braking and acceleration vs. speed, in accordance with an embodiment of the present invention.

DDMs overcome the aforementioned drawbacks of the classical approach in the following ways.
1. Frequency: Since DDMs collect second-by-second data, a driver profile is built with much less mileage and much faster.
2. Completeness: DDMs cover acceleration and braking, as well as constant speed.
3. Profiling: By counting occurrences of acceleration-speed pairs, DDMs offer more complete driver profiling.
4. Thresholding: DDMs do not require thresholding since they capture the full accelerating spectrum; hard brakes are detected based on the distribution of the acceleration for any given speed, independent of vehicle properties.

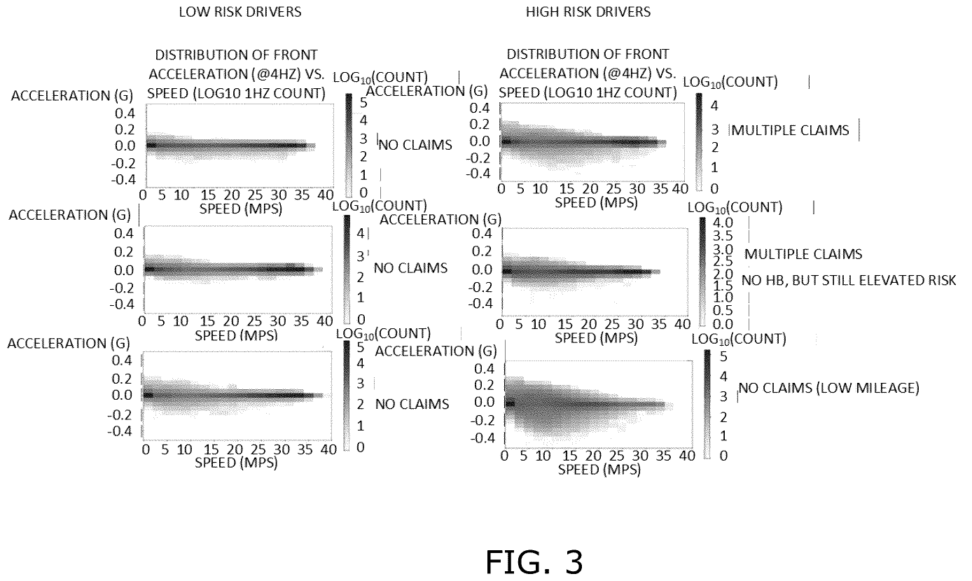

Reference is made to FIG. 3, which is a simplified drawing showing how DDMs describe different driver profiles, in accordance with an embodiment of the present invention.

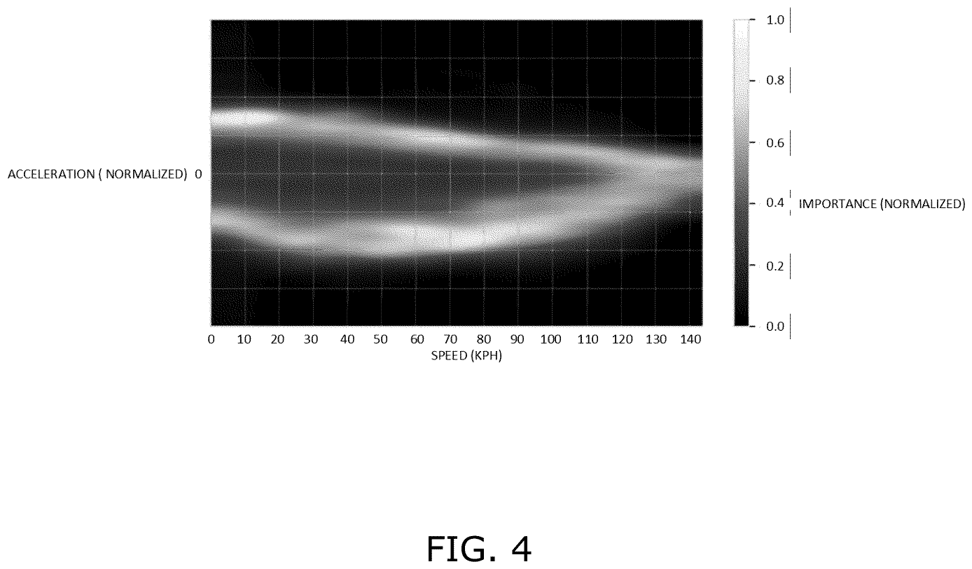

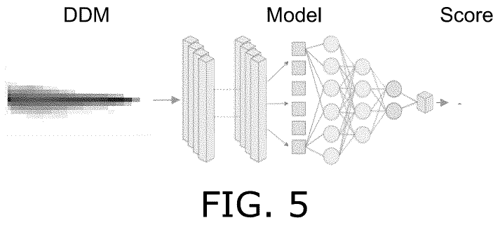

In conventional approaches, a model has a single variable (frequency of hard brakes), or a combination of weights and other types of events such as harsh acceleration and cornering, and estimating the likelihood of developing insurance claims is accomplished using simple methods including inter alia logistic regression. In distinction, according to embodiments of the present invention DDMs are represented by a number of bins per speed bin, representing a matrix that can hold over 1,000 variables. E.g., 61 acceleration levels times 20 speed levels. In addition, many of these variables are correlated. To take advantage of this rich data, machine learning is training by one or more of a neural network, a random decision forest, a gradient boosting library (XGBoost), and a support vector machine (SVM), decision trees, rule-based classifiers, nearest neighbors, logistic regression, naïve bases, and other learning models known now or to be developed. Images are pre-processed (e.g., normalized by mileage), and then presented to the network with respective labels. A machine learns to identify and classify important features in DDMs (FIG. 4), with a focus on ranking so that higher scores are associated with higher likelihoods of developing insurance claims, or other labels, if provided, such as predictions of costs of insurance claims. Preferably, the output is calibrated so that the outcome is a number between 0 and 1, representing the likelihood of developing an insurance claim. Once the machine is trained, new DDMs are classified as shown in FIG. 5.

Reference is made to FIG. 4, which is a simplified image showing the importance of the different areas of DDMs to the model, in accordance with an embodiment of the present invention. Hotter colors mean greater importance to computation of a score. FIG. 4 highlights that the relation between speed and acceleration is not constant, confirming the importance of modeling speed and acceleration together.

Reference is made to FIG. 5, which is a simplified drawing of a method for inferring the score based on a DDM using a neural network trained on DDM and insurance claim data in accordance with an embodiment of the present invention.

The models to analyze DDMs are artificial intelligence (AI) models using different DDM inputs similar to processing different color image channels with AI models that process vision. Each DDM is used as another channel. The model output is set according to end user, for example for an insurance company the output may be a simple score of risk for an insurance claim, and for fleet the output may be used provide feedback for drivers in a more structured format, where the output indicates the causes of the risk when vision DDMs are added.

For assessing the ability of the DDM model to infer insurance claims, DDM matrices were collected from NEXAR® devices with accumulated values from November until April. For each of the devices with calibration matrices and over 100 miles, it was checked if there were any insurance claims in the data provided by the insurance company, in order to correlate driver score with likelihood of filing a claim. It was also checked if the vehicle was involved in a collision event or a near-collision event, in order to correlate drive score with likelihood of a collision event. Such events were obtained by manually annotating video footage from the devices. The total number of devices used was 1,736. A 10-fold cross validation was used, where the dataset was divided into 10 folds, each fold being tested with a model trained on the remaining 9 folds. This guarantees that all devices are tested in models that were not trained on data from the test devices.

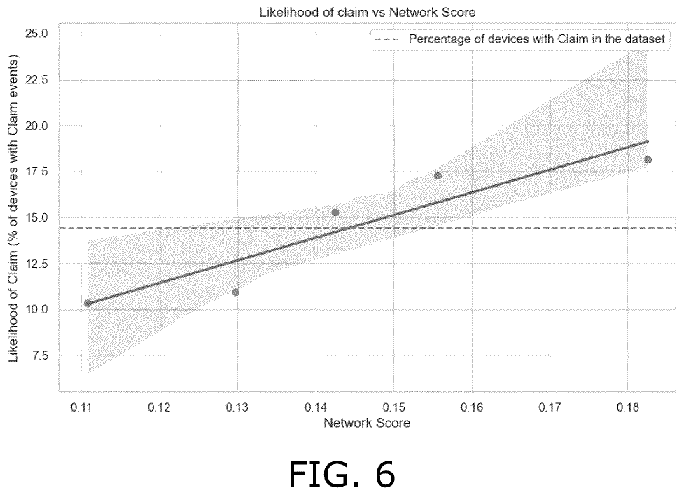

Reference is made to FIG. 6, which is a graph showing correlation between the network score and the likelihood of developing an insurance claim, in accordance with an embodiment of the present invention. FIG. 6 summarizes the results, showing a positive correlation between the network score and insurance claim likelihood. Drawbacks of the classical approach caused by having devices with insurance claims but without hard brakes, are overcome by the DDM model because embodiments of the present invention are not based on thresholds, and they leverage a full acceleration spectrum.

Embodiments of the present invention include a system to collect DDM from clients, aggregating the input sensors and then providing cloud infrastructure for efficient processing and providing end user insights, as described in what follows.

To collect inputs for DDMs, vehicle systems/sensors are used directly or a dashcam with a global navigation satellite system (GNSS) and/or on-board diagnostics (OBD) to collect speed, and other sensors such as image sensors to collection vision DDMs, accelerometers to collect vehicle acceleration/braking/cornering DDMs, and sensors to collect additional DDMs.

Since uploading raw signals of a DDM as acceleration and speed data for IMU DDMs and video for vision DDMs is high bandwidth and expensive over long-term evolution (LTE), DDMs are created on the device side. The device stores the DDMs per ride and also accumulates them for the whole extension of the device life on the local storage, and sends them over LTE at the beginning of a next ride. As such, embodiments of the present invention provide robust and low bandwidth/cost collection of driver profiles.

Since DDMs may be collected from a plurality of devices, a model to aggregate rides is done by a server that computes drivers score over a defined set of times. As such, embodiments of the present invention provide easy updating of AI models and enable observing trends over time.

Once driver score or other insights are computed by the server, a report is generated and provided by a web or an mobile application to users such as fleet managers, insurance companies and drivers themselves.

In the foregoing specification, the invention has been described with reference to specific exemplary embodiments thereof. It will, however, be evident that various modifications and changes may be made to the specific exemplary embodiments without departing from the broader spirit and scope of the invention. Accordingly, the specification and drawings are to be regarded in an illustrative rather than a restrictive sense.

What is claimed is:

1. A system for vehicle insurance actuaries, comprising:
a data collector aggregating dynamic vehicle data from sensors, the data comprising vehicle speed and acceleration, the vehicle being driven by a driver;
a data processor generating a data driver distribution matrix (DDM) from the data collected by said data collector, and pre-processing the DDM;
a convertor, representing the data DDM output by said data processor to a graphic DDM;
a server computer, training a model to learn important features of graphics that are related to likelihood of drivers submitting an insurance claim and to likely cost of claims submitted, and to assign driver scores based on graphics; and
a transmitter transmitting the graphic DDM to said server computer, wherein said server computer:
receives the graphic DDM from said transmitter;
computes a driver score from the graphic DDM, based on the model; and
infers the likelihood of the driver submitting an insurance claim and the likely cost of the submitted claim, based on the driver score.

2. The system of claim 1 wherein the sensors comprise an inertial measurement unit (IMU).

3. The system of claim 1 wherein the sensors comprise a dashcam in the vehicle.

4. The system of claim 1, wherein the model is trained by a neural network, by a random decision forest, by a gradient boosting library, and/or by a support vector machine.

5. The system of claim 1, wherein said transmitter is a long-term evolution (LTE) transmitter.

6. A method for predicting likelihood of an insurance claim by a driver, comprising:
aggregating dynamic vehicle data from sensors in a vehicle, the data comprising vehicle speed and acceleration, the vehicle being driven by a driver;
generating a data driver distribution matrix (DDM) from the data collected by said aggregating;
pre-processing the DDM generated by said generating;
representing the pre-processed DDM by a graphic DDM;
training a model to learn important features of graphics that are related to likelihood of drivers submitting an insurance claim and to likely cost of claims submitted, and to assign a driver score based on a graphic;
computing a driver score from the graphic DDM, based on the model; and
inferring the likelihood of the driver submitting an insurance claim and the likely cost of the submitted claim, based on the driver score.

7. The method of claim 6, wherein said training uses a neural network, a random decision forest, a gradient boosting library, and/or a support vector machine.

8. The method of claim 6, wherein said aggregating comprises aggregating the dynamic vehicle data from global navigation satellite systems, from vehicle on board diagnostics, from an inertial measurement unit (IMU) and/or from a dashcam in the vehicle.

9. The method of claim 6, further comprising providing feedback to drivers of a fleet regarding causes of risk, based on the model.

10. The method of claim 6, further comprising providing time series information for trends over time, based on driver scores.

11. The method of claim 10 wherein the trends comprise driver behavior.

12. The method of claim 6, further comprising rating drivers relatively with respect to a group of drivers, based on driver scores normalized among the group.

13. The method of claim 6 where the group comprises drivers of a fleet.

14. The method of claim 6, wherein said pre-processing comprises applying a logarithmic transformation to entries of the DDM.

15. The method of claim 6, wherein said pre-processing comprises normalizing the DDM by dividing entries of the DDM by the mileage.

16. The method of claim 6 wherein said representing represents the DDM as a histogram, binned according to intervals of speed.
